(19) United States
(12) Patent Application Publication
(10) Pub. No.: US 2016/0115925 A1
(43) Pub. Date: Apr. 28, 2016

(54) Fuel Injector

(71) Applicant: Perkins Engines Company Limited, Peterborough Cambridgeshire (GB)

(72) Inventors: James Darley, Peterborough, Cambridgeshire (GB); Sarah Rutledge, Peterborough, Cambridgeshire (GB); Colin White, Peterborough, Cambridgeshire (GB)

(73) Assignee: Perkins Engines Company Limited, Peterborough, Cambridgeshire (GB)

(21) Appl. No.: 14/892,085

(22) PCT Filed: May 19, 2014
(86) PCT No.: PCT/EP2014/060208

§ 371 Date: Nov. 18, 2015

(30) Foreign Application Priority Data
May 20, 2013 (EP) 13168455.7

(51) Int. Cl. F02M 61/18; F02F 1/24; F02F 3/00; F02M 61/14

(52) U.S. Cl. CPC F02M 61/1806; F02M 61/14; F02F 1/242; F02F 3/00

(57) ABSTRACT

A fuel injector for injecting fuel vapor into a combustion chamber of an internal combustion engine is disclosed. The fuel injector may be configured to reduce production of particulate matter during combustion of fuel. The fuel injector may have a spray nozzle having a tip and a plurality of spray discharge orifices formed on the tip. The plurality of spray discharge orifices being configured to discharge fuel vapor at a flow rate of 750-795 cc/min.

### TECHNICAL FIELD

This disclosure relates generally to fuel injectors for internal combustion engines, and particularly to fuel injectors for diesel engines.

### BACKGROUND

Combustion of fuel in the combustion chambers of engines may produce particulate matter, such as soot, and NOx emissions. There are on-going concerns for production of sufficient engine power while minimizing the NOx emissions in exhaust gases and minimising the amount of particulate matter retained in the combustion chamber and released through exhaust gases. Exhaust gas after-treatment devices including catalyst and particulate filters have been generally adopted to reduce NOx and particulate matter emissions in exhaust gases.

Particulate matter and NOx emissions may be dependent on factors relating to engine design and operation. These factors may include engine compression ratio, combustion chamber structure and fuel injection spray pattern. These factors may be exploited to reduce further the level of NOx and particulate matter emissions.

EP1705360, in the name of Caterpillar Inc., discloses a nozzle assembly with a nozzle body that has a centerline and defines a plurality of nozzle outlets. A first set of nozzle outlets is oriented at a first angle with respect to the centerline. A second set of nozzle outlets are oriented at a second angle with respect to the centerline. A needle valve is positioned adjacent the plurality of nozzle outlets.

The present disclosure is directed, at least in part, to improving or overcoming one or more aspects of the prior art system.

### BRIEF SUMMARY OF THE INVENTION

In a first aspect, the present disclosure describes a fuel injector for injecting fuel vapour into a combustion chamber of an internal combustion engine, comprising: an injector body having a central axis and being mountable to the combustion chamber; a spray nozzle having a tip, the spray nozzle extending longitudinally from the injector body; and a plurality of spray discharge orifices formed on the tip, the plurality of spray discharges orifices being configured to discharge fuel vapour at a flow rate of 750-795 cc/min.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is a side view of a fuel injector according to the present disclosure;

FIG. 2 is a side view of a spray nozzle assembled in the fuel injector of FIG. 1;

FIG. 3 is a side view of the unassembled spray nozzle;

FIG. 4 is a view from direction A of the tip of the spray nozzle of FIG. 3;

FIG. 5 is a plan view of a combustion washer on the fuel injector of FIG. 1; and

FIG. 6 is schematic view of the fuel injector mounted to a combustion chamber according to the present invention.

### DETAILED DESCRIPTION

This disclosure generally relates to a fuel injector 10 for reducing particulate matter production in an internal combustion engine. The fuel injector 10 may be assembled to a combustion chamber of an internal combustion engine. Fuel injector 10 may directly inject fuel into an engine cylinder, in particular into the combustion chamber of the engine cylinder.

FIG. 1 illustrates a fuel injector 10 having an injector body 12 and a spray nozzle 14. Injector body 12 may include electrical actuators that control the timing and duration of fuel vapour injection. The electrical actuator may include a biasing spring (not shown), a coil (not shown) and an armature (not shown) that may be attached to a valve member (not shown). The actuator may be any suitable electrical actuator, such as but not limited to a piezoelectric actuator or a stepper motor. The actuator may be a solenoid actuator. The valve member may be a needle valve member or a poppet valve member. The skilled person would appreciate that other suitable valve members, such as spool or ball valve members, could be substituted.

The injector body 12 may have a central axis P. Injector body 12 may be radially substantially symmetrical about central axis P, at least along a portion of its length. Injector body 12 may be mountable to the combustion chamber of an internal combustion engine.

The spray nozzle 14 may extend longitudinally from the injector body 12. Spray nozzle 14 may extend from the injector body 12 in a direction along central axis P. Spray nozzle 14 may be connected to the injector body 12. Spray nozzle 14 may have a central axis that is coincident with central axis P. Spray nozzle 14 and injector body 12 may have central axis P as a common axis.

Spray nozzle 14 may be circular in cross section. Spray nozzle 14 may have a diameter of 7.2 mm. Spray nozzle 14 may be radially symmetrical about central axis P.

Spray nozzle 14 may have a body 15 and a tip 16. Body 15 may be cylindrical. Tip 16 may extend longitudinally from the body 15. Spray nozzle 14 may extend from the spray nozzle 14 in a direction along central axis P. Tip 16 may have a central axis that is coincident with central axis P. Spray nozzle 14, injector body 12 and tip 16 may have central axis P as a common axis. Tip 16 may be radially symmetrical about central axis P.

A fuel passage (not shown) may be provided in the fuel injector 10 for flow of pressurised fuel. The fuel passage may lead from the injector body 12 to the spray nozzle 14 and to the tip 16. A needle valve member (not shown) may be positioned in the fuel passage to control the flow of the fuel. The needle valve member may abut against a valve seat (not shown) disposed in the spray nozzle 14.

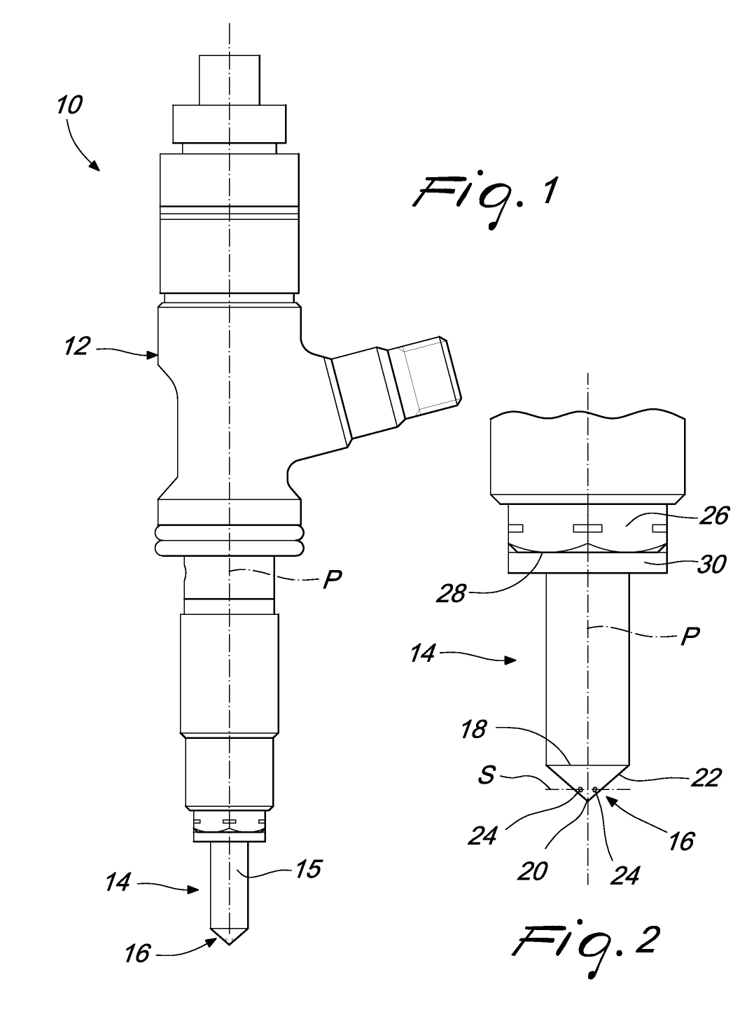

With reference to FIG. 2, the injector body 12 may further comprise a nozzle cap nut 26. Spray nozzle 14 may be mounted to the injector body 12 by the nozzle cap nut 26 which may clamp the fuel passage to the fuel passage in the spray nozzle 14. The spray nozzle 14 may extend from the nozzle cap nut 26. The spray nozzle 14 may extend axially from the nozzle cap nut 26 along central axis P. Nozzle cap nut 26 may be coaxially aligned with the spray nozzle 14.

Nozzle cap nut 26 may have a bearing surface 28 positioned opposite the injector body 12. Bearing surface 28 may represent a plane that is normal to the central axis P. Spray nozzle 14 may extend axially from the bearing surface 28 along central axis P. Spray nozzle 14 may have a nozzle length which is the axial distance from the bearing surface 28 to the tip 16. The nozzle length may be approximately 21.3 mm to 21.7 mm. The nozzle length may be approximately 21.5 mm.

With reference to FIG. 2, tip 16 may have a conical shape. The base 18 of the tip 16 may be connected to the body 15 and the apex 20 of the tip may be disposed opposite to the base 18 and the body 15. Apex 20 may be collinear with the central axis P. Tip 16 may have a side 22 that may be formed between base 18 and apex 20. Side 22 may be slanted. In an embodiment, side 22 may be concavely slanted. Side 22 may be concavely curved on the outer surface of the tip 16.

Tip 16 may comprise the valve seat that is formed on the inner surface of the side 22. Needle valve member may rest against the valve seat so as to prevent flow of fuel from the fuel passage through to the portion of the fuel passage downstream of the valve seat. Needle valve member may extend into the inner section of the tip 16. Needle valve member may be lapped in the inner section of the tip 16. Needle valve member may have a needle lift of 0.34 mm to 0.37 mm relative to the valve seat.

Fuel injector 10 may comprise a plurality of spray discharge orifice 24 formed on the tip 16. Fuel in the injector body 12 may be expelled from the plurality of spray discharge orifices 24. Fuel may be discharged from the plurality of spray discharge orifices 24 at a flow rate of 750-795 cc/min. Fuel may be expelled from the plurality of spray discharge orifices 24 at a flow rate of 770 cc/min.

The plurality of spray discharges orifice 24 may be dimensioned to inject fuel vapour at a flow rate of 750-795 cc/min into a combustion chamber. The plurality of spray discharge orifices 24 may be dimensioned to inject fuel vapour at a flow rate of 770 cc/min into a combustion chamber.

In an embodiment, each spray discharge orifice 24 may be circular. Plurality of spray discharge orifices 24 may have the same diameters. The spray discharge orifices 24 may each have a diameter of 0.156 mm.

Spray discharge orifices 24 are openings of through spray discharge passages (not shown) that extend through the tip 16. Each spray discharge orifice 24 extends through the side 22 and has an inlet (not shown) that communicates with the fuel passage. The inlets are arranged radially about the central axis P. The inlet of each spray discharge orifice 24 may be disposed downstream of the valve seat.

In an embodiment, each inlet may be circular. Plurality of inlets may have the same diameter. Each inlet may have the same diameter as the respective spray discharge orifice 24. A plane across each inlet may be parallel to a plane across the respective spray discharge orifice 24.

Each spray discharge orifice 24 is connected to the respective inlet by the spray discharge passage. The spray discharge passages may extend radially from the central axis P. In an embodiment, the plurality of spray discharge passages may have the same length.

Fuel in the fuel passage may be pressurised. Fuel may be pressurised by an external high-pressure pump (not shown). Fuel may be pressurised to a pressure of 9.8 MPa. The fuel discharged from the plurality of spray discharge orifices 24 may be at a pressure of 9.8 MPa. The fuel from the plurality of spray discharge orifices 24 may be injected into the combustion chamber at a pressure of 9.8 MPa.

The cylinder side back pressure may be at 50 bar. The leak off back pressure may be at 10 KPa. The fuel vapour may be injected at a flow rate of 770 cc/min when the cylinder side back pressure is at 5 Mpa. The fuel vapour may be injected at a flow rate of 770 cc/min when the leak off back pressure is at 10 KPa.

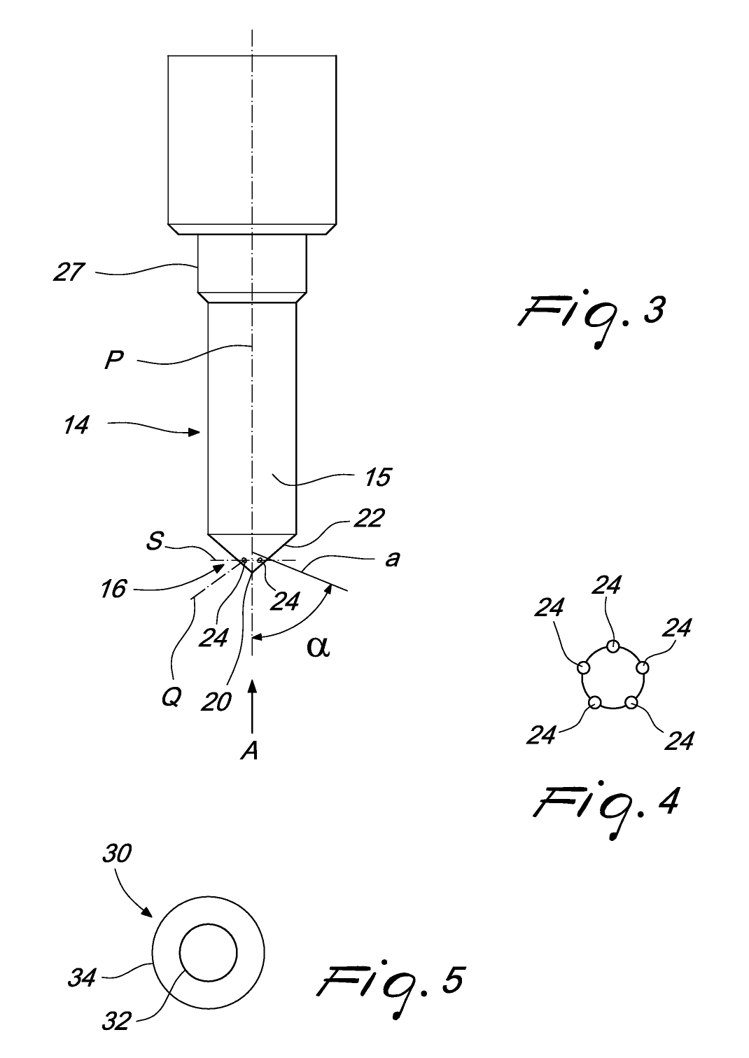

With reference to FIG. 3, body 15 of spray nozzle 14 may extend to a nozzle base 27. Body 15 may have a length of 26.45 mm to 26.55 mm. Body 15 may have a length of 26.5 mm. Nozzle base 27 may be disposed in the nozzle cap nut 26 and the injector body 12.

Each spray discharge orifice 24 may have a center axis Q. Center axis Q may pass through the centre point of each spray discharge orifice 24. In an embodiment, each centre axis Q may be transverse to a plane extending across each respective spray discharge orifice 24. In an embodiment, each spray discharge passage has a longitudinal axis that is coincident with center axis Q of respective spray discharge orifice 24. Each respective spray discharge passage may extend along the center axis Q. In an embodiment, each centre axis Q may be normal to a plane extending across each respective inlet.

Each centre axis Q may have an angle a relative to the central axis P. Each center axis Q has an angle a of approximately 65.5° to 69.5° relative to the central axis P. Each center axis Q has an angle a of approximately 67.5° relative to the central axis P.

Fuel injector 10 may have a spray cone angle that is defined by angle a. Fuel vapour may be discharged with a spray cone angle of 65.5° to 69.5° relative to the central axis P. The extent of coverage of the discharged fuel vapour may be determined by the plurality of spray discharge orifices 24 and the respective angles a relative to the central axis P. Fuel vapour from the plurality of spray discharge orifices 24 may be discharged with a spray cone angle of approximately 135° to 140°.

FIG. 4 shows the spray discharge orifices 24 on the tip 16 viewed in the direction A of the central axis P of the spray nozzle 14. The plurality of spray discharge orifices 24 may be disposed around the central axis P. Plurality of spray discharge orifices 24 may be disposed radially about the central axis P. Spray discharge orifices 24 may be equidistant from central axis P. Plurality of spray discharge orifices 24 may be mutually angularly spaced about the central axis P.

Plurality of spray discharge orifices 24 may be disposed around the apex 20. Plurality of spray discharge orifices 24 may be disposed radially about apex 20. Spray discharge orifices 24 may be equidistant from apex 20. Plurality of spray discharge orifices 24 may be mutually angularly spaced about the apex 20.

Plurality of spray discharge orifices 24 may be disposed on the circumference of the tip 16. Plurality of spray discharge orifices 24 may be disposed on the side 22 of the tip 16. Plurality of spray discharge orifices 24 may be disposed adjacent to the base 18 of the tip 16.

The fuel injector 10 may have 5 spray discharge orifices 24 disposed radially about the central axis P. Fuel injector 10 may have 5 spray discharge orifices 24 disposed radially about the apex 20. The 5 spray discharge orifices 24 may be mutually spaced about the central axis P or the apex 20. The 5 spray discharge orifices 24 may be mutually angularly spaced about the central axis P or the apex 20.

With reference to FIG. 2, the spray nozzle 14 may have a discharge orifice distance which is the axial distance from the bearing surface 28 to a spray discharge orifice 24. The discharge orifice distance may be the axial distance from the bearing surface 28 to the centre point of a spray discharge orifice 24. The discharge orifice distance may be 20.15 mm to 20.45 mm. The discharge orifice distance may be 20.30 mm.

The plurality of spray discharge orifices 24 may be arranged on a plane on the tip 16. Spray discharge orifices 24 may have a coplanar arrangement on the side 22. The plane of the spray discharge orifices 24 may be perpendicular to the central axis P.

In an embodiment, the centre point of each spray discharge orifice 24 may lie on the plane. The discharge orifice distance may be the axial distance from the bearing surface 28 to the plane S of the centre points of the spray discharge orifices 24.

In an embodiment, the circumferential point of each spray discharge orifice 24 proximate to the apex may lie on the plane S. The discharge orifice distance may be the axial distance from the bearing surface 28 to the plane S of said circumferential points of the spray discharge orifices 24.

The axial distance from the apex 20 to the spray discharge orifices 24 may be 1.15 mm to 1.25 mm. The axial distance from the apex 20 to the spray discharge orifices 24 may be 1.2 mm. The axial distance from the apex 20 to the plane of the centre points of the spray discharge orifices 24 may be 1.2 mm. The axial distance from the apex 20 to the plane of the aforesaid circumferential points of the spray discharge orifices 24 may be 1.2 mm.

With reference to FIG. 2, the fuel injector 10 may further comprise a combustion washer 30. Combustion washer 30 may be disposed about the spray nozzle 14 and in abutting contact with the bearing surface 28.

With reference to FIG. 5, combustion washer 30 may be an annulus with an inner orifice 32 and an external perimeter 34. Body 15 of the spray nozzle 14 may be inserted through the inner orifice 32. Combustion washer 30 may be coaxially aligned with the spray nozzle 14. External perimeter 34 may be flush with the surface of the nozzle cap nut 26 that is adjacent to the bearing surface 28.

Combustion washer 30 may have a diameter of 13.5 mm to 13.9 mm. Combustion washer 30 may have a diameter of 13.7 mm. The diameter of the inner orifice 32 may be 6.8 mm to 7.3 mm. The diameter of the inner orifice 32 may be 7.05 mm.

The combustion washer 30 may be made of compressible material. The combustion washer 30 may be compressed uniformly across its structure. The combustion washer 30 may have a material specification of E-Cu58 and a hardness of Hv40-50. The combustion washer 30 may have an uncompressed thickness of 1.8 mm to 1.9 mm. The combustion washer 30 may have an uncompressed thickness of 1.85 mm.

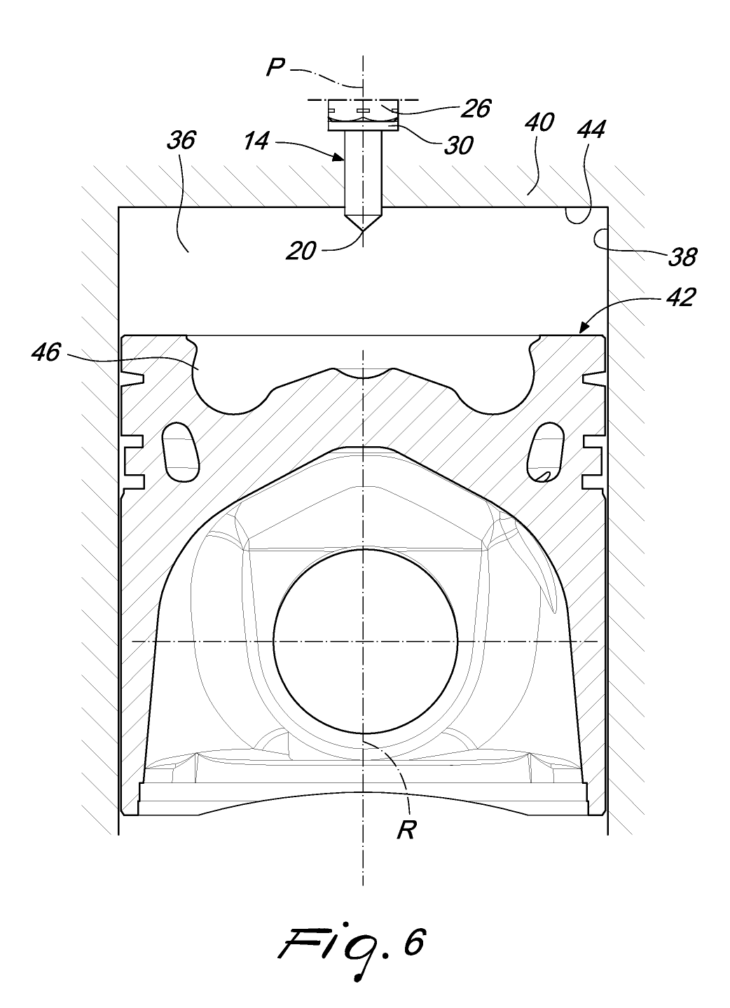

FIG. 6 illustrates a schematic sectional view of a fuel injector 10 mounted to a combustion chamber 36 of an internal combustion engine. A piston 42 may be slidably assembled into a cylinder 38 within a cylinder block. Piston 42 may have a piston bowl 46. The piston 42 may have a central axis R. The cylinder 38 may have a cylinder head 40. The cylinder head 40 may have a flame face 44. The walls of the cylinder 38 may be provided with a cylinder liner (not shown). The fuel injector 10 may be positioned in the cylinder head 40. The central axis P of the fuel injector 10 may be substantially aligned with the central axis R of the piston 42. The fuel injector 10 may have a plurality of spray discharge orifices 24 that are configured to inject fuel into the combustion chamber 36.

The combustion chamber 36 may comprise a cylinder 38; a piston 42 movable in the cylinder 38; and a cylinder head 40 including the fuel injector 10 according to any one of the preceding claims, wherein the longitudinal distance from the flame face 44 at the cylinder head 40 to the tip of the nozzle may be 2.18 mm to 2.98 mm. The longitudinal distance from the flame face 44 at the cylinder head 40 to the apex 20 of the spray nozzle 14 may be 2.58 mm.

The combustion washer 30 may be compressed with the fuel injector 10 assembled at the combustion chamber.

The skilled person would appreciate that foregoing embodiments may be modified or combined to obtain the fuel injector 10 of the present disclosure.

### INDUSTRIAL APPLICABILITY

This disclosure describes a fuel injector 10 for a diesel engine. The diesel engine may be a direct-injection engine. The diesel engine may be a four cylinder engine. The fuel injector 10 may reduce particulate matter emission in exhaust gases by decreasing the production of particulate matter during combustion of the fuel vapour in a combustion chamber. At higher injection pressures, the fuel injector 10, may provide a finer atomized spray leading to a more complete burn. Fuel vapour may be discharged with a spray cone angle of approximately 67.5° to 69.5° relative to the central axis P. With the fuel injector 10 mounted to a combustion chamber 36, the fuel vapour may be injected in a direction substantially towards the piston bowl 46.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

Where technical features mentioned in any claim are followed by reference signs, the reference signs have been included for the sole purpose of increasing the intelligibility of the claims and accordingly, neither the reference signs nor their absence have any limiting effect on the technical features as described above or on the scope of any claim elements.

One skilled in the art will realise the disclosure may be embodied in other specific forms without departing from the disclosure or essential characteristics thereof. The foregoing embodiments are therefore to be considered in all respects illustrative rather than limiting of the disclosure described herein. Scope of the invention is thus indicated by the appended claims, rather than the foregoing description, and all changes that come within the meaning and range of equivalence of the claims are therefore intended to be embraced therein.

The disclosures in European Patent Application No. 13168455.7 from which this application claims priority are incorporated herein by reference.

1. A fuel injector for injecting fuel vapor into a combustion chamber of a diesel engine, comprising:
an injector body having a central axis (P) and being mountable to the diesel engine so as to project into the combustion chamber;
a spray nozzle having a tip, the spray nozzle extending longitudinally from the injector body; and
a plurality of spray discharge orifices formed on the tip, the plurality of spray discharges orifices being configured to discharge fuel vapor at a flow rate of 750-795 cc/min.

2. The fuel injector according to claim 1 wherein the fuel vapor is discharged at a flow rate of 770 cc/min.

3. The fuel injector according to claim 1 wherein the fuel vapor is discharged at a pressure of 9.8 MPa.

4. The fuel injector according to claim 3 wherein a cylinder side back pressure is 5 Mpa.

5. The fuel injector according to claim 3 wherein the leak off back pressure is 10 KPa.

6. The fuel injector according to claim 1 wherein each spray discharge orifice has a center axis having an angle (α) of approximately 65.50 to 69.50 relative to the central axis (P).

7. The fuel injector according to claim 6 wherein each spray discharge orifice has a center axis (Q) having an angle (α) of approximately 67.50 relative to the central axis (P).

8. The fuel injector according to claim 1 comprising five spray discharge orifices disposed radially about the central axis (P).

9. The fuel injector according to claim 8 wherein the five spray discharge orifices are mutually angularly spaced about the central axis (P).

10. The fuel injector according to claim 1 wherein the apex of the tip is collinear with the central axis (P).

11. The fuel injector according to claim 1 wherein the spray nozzle axially extends from a bearing surface on the injector body, wherein the spray nozzle (12) has a nozzle length of approximately 21.3 mm to 21.7 mm.

12. The fuel injector according to claim 11 wherein the spray nozzle has a discharge orifice distance of approximately 20.15 mm to 20.45 mm.

13. The fuel injector according to claim 11 further comprising a combustion washer disposed about the spray nozzle at the bearing surface, wherein the combustion washer has an uncompressed thickness of 1.8 mm to 1.9 mm.

14. The fuel injector according to claim 13 wherein the combustion washer has a material specification of E-Cu58 and a hardness of Hv40-50.

15. A combustion chamber of a diesel engine, comprising:
a cylinder;
a piston movable in the cylinder; and
a cylinder head including the fuel injector according to claim 1, wherein the longitudinal distance from a flame face at the cylinder head to the apex of the spray nozzle is 2.18 mm to 2.98 mm.

16. The fuel injector according to claim 2 wherein each spray discharge orifice has a center axis (Q) having an angle (α) of approximately 65.50 to 69.50 relative to the central axis (P).

17. The fuel injector according to claim 2 wherein each spray discharge orifice has a center axis (Q) having an angle (α) of approximately 65.50 to 69.50 relative to the central axis (P).

18. The fuel injector according to claim 2 wherein each spray discharge orifice has a center axis (Q) having an angle (α) of approximately 65.50 to 69.50 relative to the central axis (P).

19. The fuel injector according to claim 2 wherein the fuel vapor is discharged at a pressure of 9.8 MPa, a cylinder side back pressure is 5 Mpa.

20. The fuel injector according to claim 19 wherein each spray discharge orifice has a center axis (Q) having an angle (α) of approximately 65.50 to 69.50 relative to the central axis (P).
